(19) United States
(12) Patent Application Publication
(10) Pub. No.: US 2007/0096402 A1
(43) Pub. Date: May 3, 2007

(54) Reduced contact area gasket

(75) Inventor: James T. Lingenfelder, Katy, TX (US)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Gasket Resources Incorporated

(21) Appl. No.: 11/259,060

(22) Filed: Oct. 27, 2005

(51) Int. Cl. F16L 17/06

(52) U.S. Cl. 277/608

(57) ABSTRACT

A reduced contact area gasket is adapted to be disposed between first and second flanges in a piping system. The reduced area gasket has an outer portion having a first outer perimeter and a first inner perimeter. At least two recesses extend inwardly from the outer perimeter. Each of the at least two recesses is adapted to receive a fastener that secures the first and second flanges between which the reduced contact area gasket is adapted to be disposed. An inner portion of the reduced contact area gasket has a second inner perimeter that defines an aperture therethrough and a second outer perimeter. The at least two recesses are connected to the second outer perimeter. At least two cutout portions extend from a first surface to a second opposite surface of the reduced contact area gasket.

### FIELD OF THE INVENTION

The present invention relates to a reduced contact area gasket. More particularly, the present invention relates to a reduced contact area gasket having inwardly extending recesses from an outer perimeter of the gasket that facilitate installation of the gasket between flanges. Still more particularly, the present invention relates to a sealing system having a reduced contact area gasket disposed between a pair of flanges.

### BACKGROUND OF THE INVENTION

Gaskets are used to provide a seal between mating flanges in piping systems, on apparatus having mating flanges, and in numerous other applications requiring seals. Low seating stresses (that is, the stress required to deform the gasket to the flange surfaces to provide the seal) are often preferred for certain sealing applications. Reduced contact area gaskets require a reduced seating stress to provide a good seal. However, several problems exist with conventional reduced contact area gaskets.

One problem with conventional reduced contact area gaskets is that the fastener holes in the gasket are spaced inwardly from an outer perimeter of the gasket. Therefore, all fasteners must be removed from between the mating flanges prior to installing the gasket. The gasket must then be properly positioned such that the fastener holes in gasket are aligned with the fastener holes in the gaskets. Properly positioning the gasket often proves to be an awkward task, as well as time consuming. Thus, a need exists for a reduced contact area gasket that is quickly located between the mating flanges.

Another problem with existing reduced contact area gaskets is that the gasket is awkward to handle when being installed between mating flanges, particularly because the gasket does not extend beyond the outer diameter of the mating flanges. The gasket must be held between the mating flanges such that the fastener holes may be aligned. The space between the faces of the mating flanges is often small, such that holding the gasket in the space is difficult. Thus, a need exists for a reduced contact area that is easily handled to facilitate gasket installation.

Still another problem with existing reduced contact area gaskets is that when a gasket needs to be replaced there is no quick and easy way to ascertain information about the current gasket to facilitate its replacement. Research must often be conducted to obtain information about the proper gasket to be used, which often requires investigation of the specifications of the piping system or apparatus in which the gasket is to be used to determine the proper replacement. Alternatively, the gasket to be replaced can be removed to determine if gasket identifying indicia, such as the gasket material and size, is marked on the gasket. Thus, a need exists for a reduced contact area gasket that facilitates gasket identification and replacement.

Examples of existing reduced contact area gaskets are disclosed in U.S. Pat. No. 5,362,115 to Carr; U.S. Pat. No. 6,682,081 to Burton et al.; and U.S. Pat. No. 6,869,081 to Jenco, the entire disclosures of each of which are hereby incorporated by reference.

Therefore, a need exists for improved reduced contact area gaskets.

### SUMMARY OF THE INVENTION

Accordingly, it is an objective of the present invention to provide a gasket having a reduced contact area, thereby reducing the seating stress and preventing damage to the gasket and flanges during installation.

Accordingly, another objective of the present invention is to provide a reduced contact area gasket that is easily disposed between mating flanges.

Accordingly, another objective of the present invention is to provide a reduced contact area gasket that is easily disposed between mating flanges already connected by a fastener.

Accordingly, still another objective of the present invention is to provide a reduced contact area gasket that is easily identifiable to facilitate replacement thereof.

The foregoing objectives are basically attained by providing a reduced contact area gasket that is adapted to be disposed between first and second flanges in a piping system. The reduced area gasket has an outer portion having a first outer perimeter and a first inner perimeter. At least two recesses extend inwardly from the outer perimeter. Each of the at least two recesses is adapted to receive a fastener that secures the first and second flanges between which the reduced contact area gasket is adapted to be disposed. An inner portion of the reduced contact area gasket has a second inner perimeter that defines an aperture therethrough and a second outer perimeter. The at least two recesses are connected to the second outer perimeter. At least two cutout portions extend from a first surface to a second opposite surface of the reduced contact area gasket.

The foregoing objectives are also basically attained by providing a sealing system, which includes a reduced contact area gasket disposed between first and second flanges of a piping system. The second flange is secured to the first flange with at least two fasteners. The reduced contact area gasket has an outer portion having a first outer perimeter and a first inner perimeter. At least two recesses extend inwardly from the outer perimeter and are adapted to receive the at least two fasteners. One of the at least two recesses is adapted to receive one of the two fasteners when the fastener is disposed between the first and second flanges. An inner portion of the reduced contact area gasket has a second inner perimeter defining an aperture therethrough and a second outer perimeter. The at least two recesses are connected to the second outer perimeter. At least two cutout portions extend from a first surface to a second opposite surface of the reduced contact area gasket.

Other objects, advantages and salient features of the invention will become apparent from the following detailed description, which, taken in conjunction with the annexed drawings, discloses exemplary embodiments of the invention.

### BRIEF DESCRIPTION OF THE DRAWINGS

Referring now to the drawings that form a part of the original disclosure:

FIG. 1 is a side elevational view of a reduced contact area gasket disposed between first and second flanges;

FIG. 2 is a top plan view of a reduced contact area gasket having four recesses and four cutout portions according to a first embodiment of the present invention;

FIG. 3 is a side elevational view of the reduced contact area gasket of FIG. 2;

FIG. 4 is a side elevational view in section of the reduced contact gasket along line 4-4 of FIG. 2;

FIG. 5 is a top plan view of a reduced gasket area having eight recesses and eight cutout portions according to a second embodiment of the present invention in which the recesses are connected to an inner portion of the gasket by a connecting arm; and

FIG. 6 is a top plan view of a reduced area gasket having eight recesses and eight cutout portions according to a third exemplary embodiment of the present invention in which the recesses are directly connected to an inner portion of the gasket.

Throughout the drawings, like reference numerals will be understood to refer to like parts, components and structures.

### DETAILED DESCRIPTION OF THE INVENTION

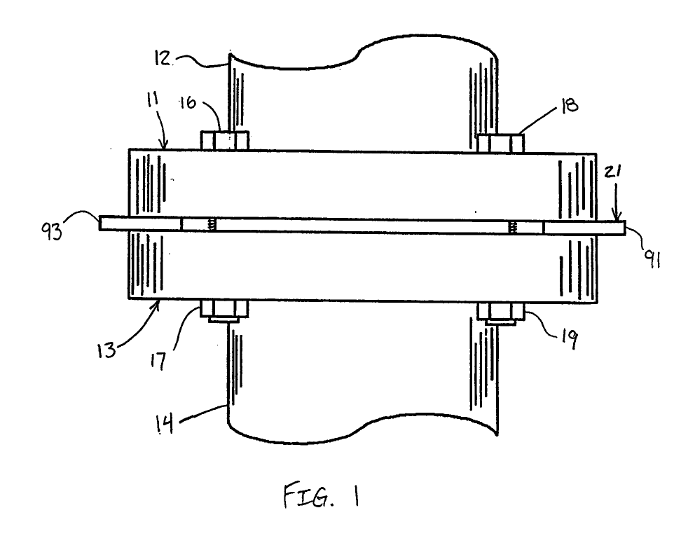

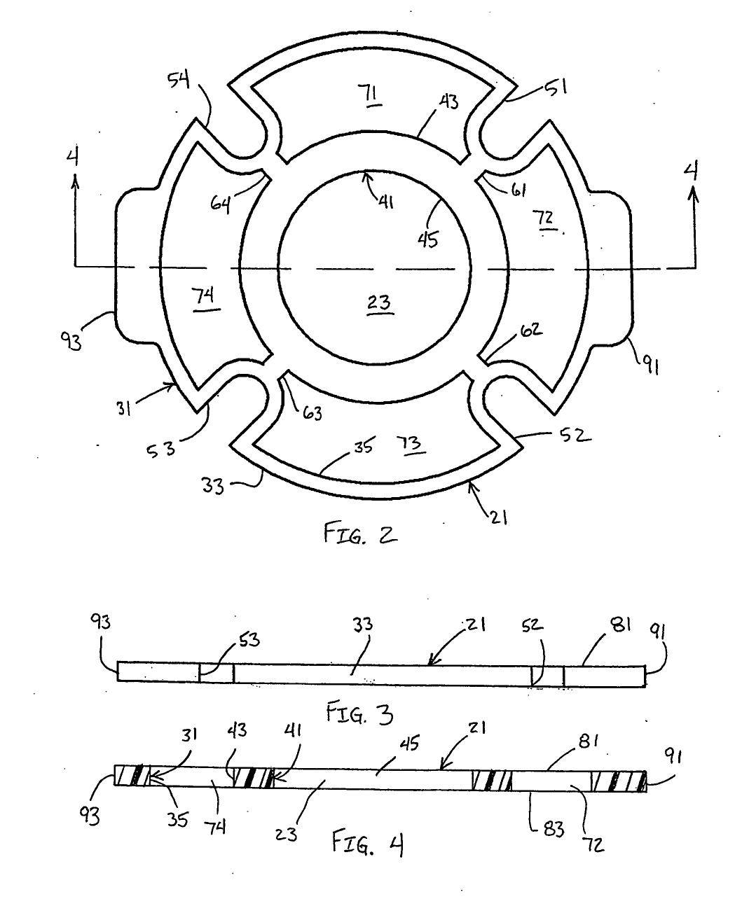

As shown in FIGS. 1-6, the present invention relates to a reduced contact area gasket 21 adapted to be disposed between first and second flanges 11 and 13 in a piping system. The reduced contact area gasket 21 has an outer portion 31 having a first outer perimeter 33 and a first inner perimeter 35. At least two recesses 51 and 52 extend inwardly from the first outer perimeter 33. Each of the at least two recesses 51 and 52 are adapted to receive fasteners 16 and 18 that secure the first and second flanges 11 and 13 between which the reduced contact area gasket 21 is adapted to be disposed. An inner portion 41 of the reduced contact area gasket 21 has a second inner perimeter 45 that defines an aperture 23 therethrough and a second outer perimeter 43. The at least two recesses 51 and 52 are connected to the second outer perimeter 43. At least two cutout portions 71 and 72 extend from a first surface 81 to a second surface 83 of the reduced contact area gasket 21.

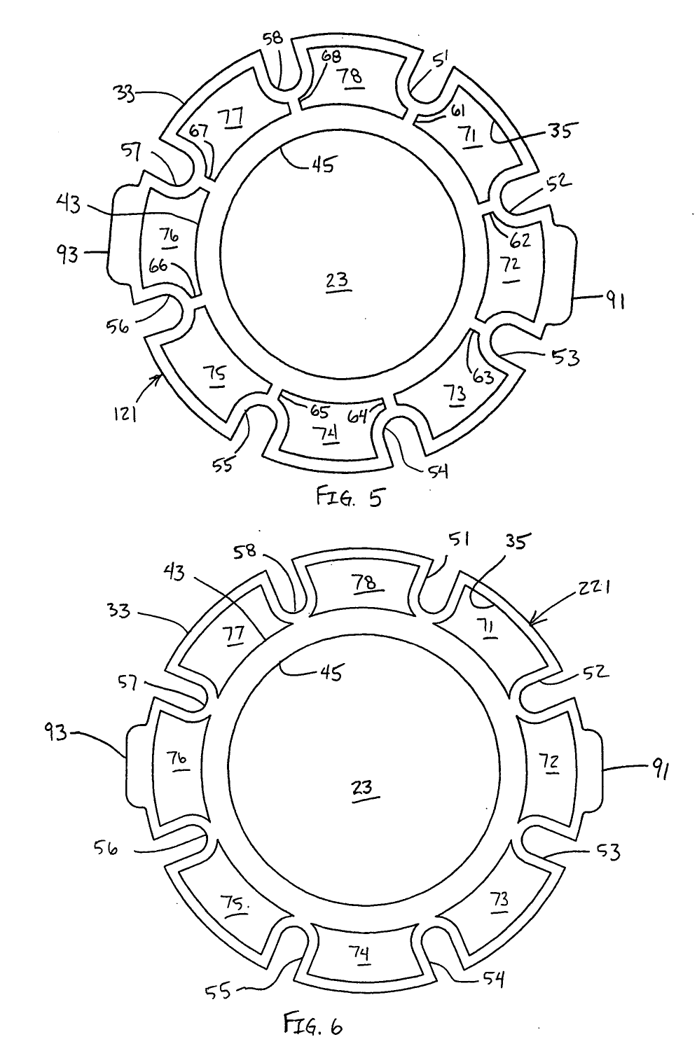

A first exemplary embodiment of a reduced contact area gasket 21 according to the present invention has four recesses 51-54 and four cutout portions 71-74, as shown in FIG. 2. A second exemplary embodiment of a reduced contact area gasket 221 of the present invention has eight recesses 51-58 and eight cutout portions 71-78, as shown in FIGS. 5 and 6. The reduced contact area gasket of the present invention may have any number of recesses and cutout portions suitable for the intended application of the gasket. Preferably, the number of cutout portions 71 corresponds to the number of recesses 51.

The reduced contact area gaskets 21, 121 and 221 according to exemplary embodiments of the present invention, as shown in FIGS. 2-8, have a first outer portion 31 having a first outer perimeter 33 and a first inner perimeter 35. Preferably, the first inner perimeter 35 is substantially co-axial to the first outer perimeter 33. The first outer perimeter 35 extends inwardly to form a recess 51 that corresponds to aligned fastener holes in the mating flanges 11 and 13 between which the reduced contact area gasket 21 is adapted to be disposed. As shown in FIG. 2, four recesses 51-54 are substantially equidistantly spaced along the first outer perimeter 33. As shown in FIGS. 5 and 6, eight recesses 51-58 are substantially equidistantly spaced along the first outer perimeter 33. Although exemplary embodiments are shown having four and eight recesses, the gasket may have any number of recesses greater than one.

An inner portion 41 is connected to the outer portion 31. The inner portion 41 has a second outer perimeter 43 and a second inner perimeter 45. The second inner perimeter 45 defines an aperture 23 that is aligned with the apertures in the mating flanges 11 and 13 to create a fluid flowpath therethrough. Preferably, the second inner perimeter 45 is substantially parallel to the second outer perimeter 43.

As shown in FIGS. 2 and 5, a connecting arm 61 may connect the inner and outer portions 41 and 31. Preferably, a connecting arm 61 extends from the first inner perimeter 35 of each recess 51 to the second outer perimeter 43 of the inner portion 41. Thus, in FIG. 2, four connecting arms 61-64 connect each of the recesses 51-54 to the second outer perimeter 43. As shown in FIG. 5, eight connecting arms 61-68 connect each of the recesses 51-58 to the second outer perimeter 43.

Alternatively, as shown in FIG. 6, the outer portion 41 may be directly connected to the inner portion 31, such that the first inner perimeter 35 is connected to the second outer perimeter 43 at each recess 51. Thus, as shown in FIG. 6, each of the recesses 51-58 is directly connected to the second outer perimeter 43 (that is, there is no connecting arm between the recess and the second outer perimeter).

A cutout portion 71 in the reduced contact area gasket reduces the amount of contact area between the first and second surfaces 81 and 83 of the gasket and the first and second flanges 11 and 13, thereby reducing the seating stress. As shown in FIG. 4, the cutout portions extend completely through the gasket 21 from the first surface 81 to the second surface 83. The cutout portion is defined by the first inner perimeter 35, the second outer perimeter 43 and adjacent recesses. Thus, as shown in FIGS. 2 and 5, cutout portion 71 is defined by the first inner perimeter 35 (including the inner perimeter of the adjacent recesses 51 and 52), the second outer perimeter 43 and the adjacent connecting arms 61 and 62. A cutout portion 71 of FIG. 6 is defined by the first inner perimeter 35 (including the inner perimeter of the adjacent recesses 51 and 52) and the second outer perimeter 43.

At least one tab 91 or 93 extends outwardly from the first outer perimeter 33, as shown in FIGS. 2, 5 and 6. Preferably, the tab 91 is marked with indicia identifying the gasket, such as the size and material of the gasket, thereby facilitating replacement of the gasket when necessary. Furthermore, the tab 91 is a convenient handle during gasket installation because the tab extends beyond the outer diameter of the mating flanges 11 and 13, as shown in FIG. 1. By extending beyond the outer diameter of the mating flanges, identifying indicia marked on the tab is easily readable while the gasket is installed between the mating flanges, thereby preventing the flanges from having to be disconnected to obtain information about the gasket. Preferably, the reduced contact area gasket has first and second tabs 91 and 93 that extend in substantially opposite directions, as shown in FIGS. 2, 5 and 6.

The reduced contact area gasket 21, 121 and 221 according to exemplary embodiments of the present invention is preferably unitarily formed as a single piece. The reduced contact area gasket may be used in any suitable application, including between metallic and nonmetallic flanges of piping systems and apparatuses. The reduced contact area gasket is particularly useful in chemical, pulp and paper, food and beverage and other general industrial applications. The gasket may be made of any material suitable for the intended application, such as, but not limited to, rubber or plastic. Preferably, the reduced contact area gasket is made of polytetrafluoroethylene, which is particularly useful in applications where resistance to highly aggressive chemicals is required.

Assembly, Disassembly and Operation

The reduced contact area gasket 21 is shown disposed between first and second flanges 11 and 13 in FIG. 1, thereby forming a sealing system. The first flange 11 is disposed at an end of a first section of pipe 12 and the second flange 13 is disposed at an end of a second section of pipe 14. Fasteners 16 and 18 and nuts 17 and 19 secure the flanges 11 and 13 together.

To install the reduced contact area gasket, preferably, one fastener 16 secures the first and second flanges 11 and 13 together. A reduced contact area gasket accordingly to an exemplary embodiment of the present invention is inserted between the first and second flanges such that one of the recesses 51 receives the fastener, thereby facilitating proper positioning of the gasket between the flanges. The engaged recess acts as an alignment guide such that proper positioning of the gasket between the mating flanges 11 and 13 is quickly and easily achieved. Because the recesses are open at the outer perimeter 33 of the gasket, all of the fasteners do not need to be removed from the first and second flanges during gasket installation.

The tab 91 permits an installer to easily handle the gasket during installation by providing a surface to grip that is not disposed between the mating flanges. Furthermore, the tab 91 prevents an installer from having to reach between the narrow gap between the surfaces of the mating flanges to position the gasket during installation.

Once the gasket has been properly positioned such that the gasket recesses are aligned with the fastener holes in the flanges 11 and 13, the remaining fasteners are inserted and/or tightened. The fasteners are then tightened in the appropriate tightening sequence for the application. The reduced contact area of the gasket with the flanges reduces the required gasket seating stress, thereby substantially preventing gasket and flange damage during gasket installation. Furthermore, the outer portion 31 of the gasket substantially prevents rotation of the flanges 11 and 13 during gasket installation.

While advantageous embodiments have been chosen to illustrate the invention, it will be understood by those skilled in the art that various changes and modifications may be made therein without departing from the scope of the invention as defined in the appended claims.

What is claimed is:

1. A reduced contact area gasket, comprising:
an outer portion having a first outer perimeter and a first inner perimeter;
at least two recesses extending inwardly from said outer perimeter, each of said at least two recesses being adapted to receive a fastener that secures flanges between which the reduced contact area gasket is adapted to be disposed;
an inner portion having a second inner perimeter defining an aperture therethrough and a second outer perimeter, said at least two recesses being connected to said second outer perimeter; and
at least two cutout portions extending from a first surface to a second opposite surface of said reduced contact area gasket.

2. A reduced contact area gasket according to claim 1, wherein
each of said at least two recesses is connected to said second outer perimeter by a connecting arm.

3. A reduced contact area gasket according to claim 1, wherein
at least one tab extends outwardly from said first outer perimeter of said outer portion.

4. A reduced contact area gasket according to claim 3, wherein
said at least tab is marked with indicia identifying said reduced contact area gasket.

5. A reduced contact area gasket according to claim 1, wherein
first and second tabs extend outwardly from said first outer perimeter of said outer portion, said first and second tabs extending in substantially opposite directions.

6. A reduced contact area gasket according to claim 1, wherein
each of said at least one cutout portions is defined by said first inner perimeter, said second outer perimeter and adjacent recesses.

7. A reduced contact area gasket according to claim 2, wherein
each of said at least one cutout portions is defined by said first inner perimeter, said second outer perimeter, adjacent recesses and adjacent connecting arms.

8. A reduced contact area gasket according to claim 1, wherein
said reduced contact area gasket has four recesses and four cutout portions.

9. A reduced contact area gasket according to claim 1, wherein
said reduced contact area gasket has eight recesses and eight cutout portions.

10. A reduced contact area gasket according to claim 1, wherein
said reduced contact area gasket is unitarily formed as a single piece.

11. A reduced contact area gasket according to claim 1, wherein
said reduced contact area gasket is made of polytetrafluoroethylene.

12. A reduced contact area gasket, comprising:
an outer portion having a first outer perimeter and a first inner perimeter;
eight recesses extending inwardly from said outer perimeter, each of said eight recesses being adapted to receive a fastener that secures flanges between which the reduced contact area gasket is adapted to be disposed;
an inner portion having a second inner perimeter defining an aperture therethrough and a second outer perimeter, said eight recesses being connected to said second outer perimeter; and
eight cutout portions extending from a first surface to a second opposite surface of said reduced contact area gasket, each of said cutout portions being defined by said first inner perimeter, said second outer perimeter and adjacently disposed recesses.

13. A reduced contact area gasket according to claim 12, wherein each of said eight recesses is connected to said second outer perimeter by a connecting arm.

14. A reduced contact area gasket according to claim 12, wherein
said reduced contact area gasket is unitarily formed as a single piece.

15. A reduced contact area gasket according to claim 12, wherein
said reduced contact area gasket is made of polytetrafluoroethylene.

16. A reduced contact area gasket according to claim 12, wherein
first and second tabs extend outwardly from said first outer perimeter of said outer portion, said first and second tabs extending in substantially opposite directions.

17. A sealing system, comprising:
a first flange;
a second flange secured to the first flange with at least two fasteners; and
a reduced contact area gasket disposed between the first and second flanges, said reduced contact area including
an outer portion having a first outer perimeter and a first inner perimeter;
at least two recesses extending inwardly from said outer perimeter and adapted to receive said at least two fasteners, one of said at least two recesses being adapted to receive one of said two fasteners when said fastener is disposed between said first and second flanges;
an inner portion having a second inner perimeter defining an aperture therethrough and a second outer perimeter, said at least two recesses be connected to said second outer perimeter; and
at least two cutout portions extending from a first surface to a second opposite surface of said gasket.

18. A sealing system according to claim 17, wherein
said reduced contact area gasket is unitarily formed as a single piece.

19. A sealing system according to claim 17, wherein
first and second tabs extend outwardly from said first outer perimeter of said outer portion, said first and second tabs extending in substantially opposite directions.

20. A sealing system according to claim 19, wherein
said first and second tabs extend outwardly beyond said first and second flanges to facilitate installation of said reduced contact area gasket.
